(19) United States
(12) Patent Application Publication
(10) Pub. No.: US 2017/0089586 A1
(43) Pub. Date: Mar. 30, 2017

(54) GAS KNOB ALIGNMENT BRACKETS

(71) Applicant: General Electric Company, Schenectady, NY (US)

(72) Inventor: Darren Allen Turner, Louisville, KY (US)

(21) Appl. No.: 14/870,062

(22) Filed: Sep. 30, 2015

(51) Int. Cl. F24C 3/12; F16K 31/50

(52) U.S. Cl. CPC F24C 3/122; F16K 31/50; F24C 3/124

(57) ABSTRACT

Gas valve mounting brackets improving the positioning of the valve stems in the aperture of gas cooking appliance as well as the alignment of the knobs with any graphics or insignia. In one aspect, a bracket directly couples a gas valve to a bottom surface of a cooktop of cooktop appliance. This direct coupling more accurately positions a valve stem of the gas valve in the center of a cooktop aperture through which it extends. A knob attached to the valve stem is also more accurately aligned with graphics and/or insignia on the cooktop.

### FIELD OF THE INVENTION

The subject matter of the present disclosure relates generally to a cooktop appliance, and more specifically to a gas valve mounting assembly for a cooktop appliance.

### BACKGROUND OF THE INVENTION

Certain cooktop appliances may include one or more gas burner heating elements for cooking food items thereon. In this respect, such cooktop appliances may include a manifold that receives gas from, e.g., an external gas source, and distributes the gas to the one or more gas burner heating elements. Specifically, a gas valve corresponding to each of the one or more gas burner heating elements may control the flow of gas from the manifold to that particular gas burner heating element. Each gas valve includes an outwardly-extending valve stem, which controls the position thereof.

A knob connected to a valve stem permits users to open and close each gas valve, thereby increasing or decreasing the temperature of the respective gas burner heating element. Typically, each valve stem extends through an aperture in the cooktop surface. In this respect, the gas valves are positioned internally within the cooktop appliance, and the knobs are positioned externally of the cooktop appliance to permit easy actuation by the user.

A cooktop surface associated the cooktop appliance typically includes graphics or other insignia proximate to each aperture indicating how the position of the respective knob corresponds to the position of the respective gas valve. For example, the cooktop surface may have a low heat marking, a medium heat marking, and a high heat marking. In this respect, the gas valve permits only a relatively low gas flow rate therethrough when the knob is aligned with the low heat marking. When the gas valve is aligned with the medium heat marking, the gas valve permits a relative higher gas flow rate therethrough. The gas valve permits even greater gas flow rate therethrough when the knob is aligned with the high heat marking.

The alignment of the valve stems and/or knobs relative to the apertures in and the graphics on the cooktop surface is an indicator of overall quality of the cooktop appliance to some consumers. But, conventional methods of positioning the knobs may result in inaccurate alignment thereof relative to the apertures and/or graphics. More specifically, sheet metal brackets formed via stamping and/or bending may attach the manifold to the cooktop surface. The gas valves, in turn, attach to the manifold, and the knobs attach to the gas valves via the valve stems. These sheet metal brackets may exhibit a high level of dimensional variation, which may result in a tolerance stack up that could result in inaccurate positioning of the knobs and/or valve stems relative to the apertures and/or graphics.

Therefore, an improved gas knob mounting assembly for a cooktop appliance would be useful. More particularly, a gas knob mounting assembly for a cooktop appliance that improves the positioning of the valve stem in the aperture and the alignment of the knobs with any graphics or insignia would be particularly beneficial.

### BRIEF DESCRIPTION OF THE INVENTION

Aspects and advantages of the invention will be set forth in part in the following description, may be apparent from the description, or may be learned through practice of the invention.

The gas valve mounting brackets disclosed herein improve the positioning of the valve stems in the aperture as well as the alignment of the knobs with any graphics or insignia. One embodiment of the bracket directly couples a gas valve to a bottom surface of a cooktop of cooktop appliance. This direct coupling more accurately positions a valve stem of the gas valve in the center of a cooktop aperture through which it extends. A knob attached to the valve stem is also more accurately aligned with graphics and/or insignia on the cooktop. Furthermore, this embodiment and other embodiments of the gas valve mounting bracket can be produced via die casting or injection molding. In this respect, the gas valve mounting bracket has tighter tolerances and greater repeatability than conventional sheet metal brackets, further improving the positioning of the valve stem and the alignment of the knob.

In one aspect of the present disclosure, a gas valve mounting assembly includes a gas valve having a valve body and a valve stem, which extends outwardly from the valve body. The valve stem defines a valve stem axis. A radial direction is defined orthogonal to the valve stem axis, and a circumferential directional is defined concentric to the valve stem axis. The gas valve mounting assembly further includes a bracket having a first flange and a first flange aperture defined by the first flange and aligned with the valve stem axis. The valve body is received at least partially within the first flange aperture. The bracket includes a second flange for attachment to a cooktop. The second flange spaced apart from the first flange along the valve stem axis. The second flange defines a second flange aperture through which the valve stem extends from the valve body. A plurality of connectors disposed on the second flange attaches the bracket to the cooktop.

In another aspect of the present disclosure, a cooking appliance includes a manifold for supplying gas to one or more burners. A gas valve controls the flow of gas out of the manifold. The gas valve includes a valve body and a valve stem extending outwardly from the valve body and defining a valve stem axis. A radial direction is defined orthogonal to the valve stem axis, and a circumferential directional is defined concentric to the valve stem axis. A bracket for mounting the gas valve to a cooktop includes a first flange, which defines a first flange aperture aligned with the valve stem axis. The first flange at least partially receives the valve body. A second flange, which attaches to a cooktop, is spaced apart from the first flange along the valve stem axis. The second flange defines a second flange aperture through which the valve stem extends from the valve body. A plurality of legs extends between the first flange and the second flange. At least one passageway is defined between each adjacent pair of the plurality of legs to permit air flow therethrough from an aperture in the cooktop to a burner. A plurality of connectors disposed on the second flange attaches the bracket to the cooktop.

In a further aspect of the present disclosure, a gas valve mounting assembly includes a gas valve and a bracket. The bracket includes a first flange, which attaches to a cooktop. The bracket further includes a first flange and a notch defined by the first flange for receiving a manifold. A first wall extends between the first flange and the second flange. A second wall extends between the first flange and the second flange. The second wall is disposed at an angle relative to the first wall. A third wall extends between the first flange and the second flange. The third wall intersects the first wall and is disposed at an angle relative to the first wall and the second wall. A plurality of connectors disposed on the second flange attaches the bracket to the cooktop.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a top view of a cooktop appliance including a cooktop and a control panel in accordance with the embodiments disclosed herein.

FIG. 2 is a side view of the cooktop appliance in accordance with the embodiments disclosed herein, illustrating a first embodiment of a bracket for attaching a gas valve to the cooktop.

FIG. 3 is perspective view of a gas valve mounted to a bottom surface of the cooktop.

FIG. 4 is a perspective view of the control panel with the cooktop removed.

FIG. 5 is an enlarged perspective view of the gas valve and the first embodiment of the bracket for mounting the same to the bottom surface of the cooktop.

FIG. 6 is an alternate enlarged perspective view of the gas valve and the first embodiment of the bracket for mounting the same to the bottom surface of the cooktop.

FIG. 7 is an exploded perspective view of similar to FIGS. 5-6, illustrating the mounting of the first embodiment of the bracket to the gas valve.

FIG. 8 is a perspective view of the first embodiment of the bracket in accordance with the embodiments disclosed herein.

FIG. 9 is a top view of the first embodiment of the bracket in accordance with the embodiments disclosed herein.

FIG. 10 is a front view of the first embodiment of the bracket in accordance with the embodiments disclosed herein.

FIG. 11 is a side view of the first embodiment of the bracket in accordance with the embodiments disclosed herein.

FIG. 12 is a side view of the cooktop appliance, illustrating a second embodiment of the bracket, which couples a manifold to the cooktop.

FIG. 13 is a perspective view of the second embodiment of the bracket with the corresponding gas valve removed.

FIG. 14 is an enlarged alternate perspective view of the second embodiment of the bracket with the corresponding gas valve removed.

FIG. 15 is a side view of the second embodiment of the bracket with the corresponding gas valve removed.

FIG. 16 is a perspective view of the second embodiment of the bracket with the corresponding gas valve shown.

FIG. 17 is a perspective view of the second embodiment of the bracket in accordance with the embodiments disclosed herein.

FIG. 18 is a side view of the second embodiment of the bracket in accordance with the embodiments disclosed herein.

FIG. 19 is a top side view of the second embodiment of the bracket in accordance with the embodiments disclosed herein.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

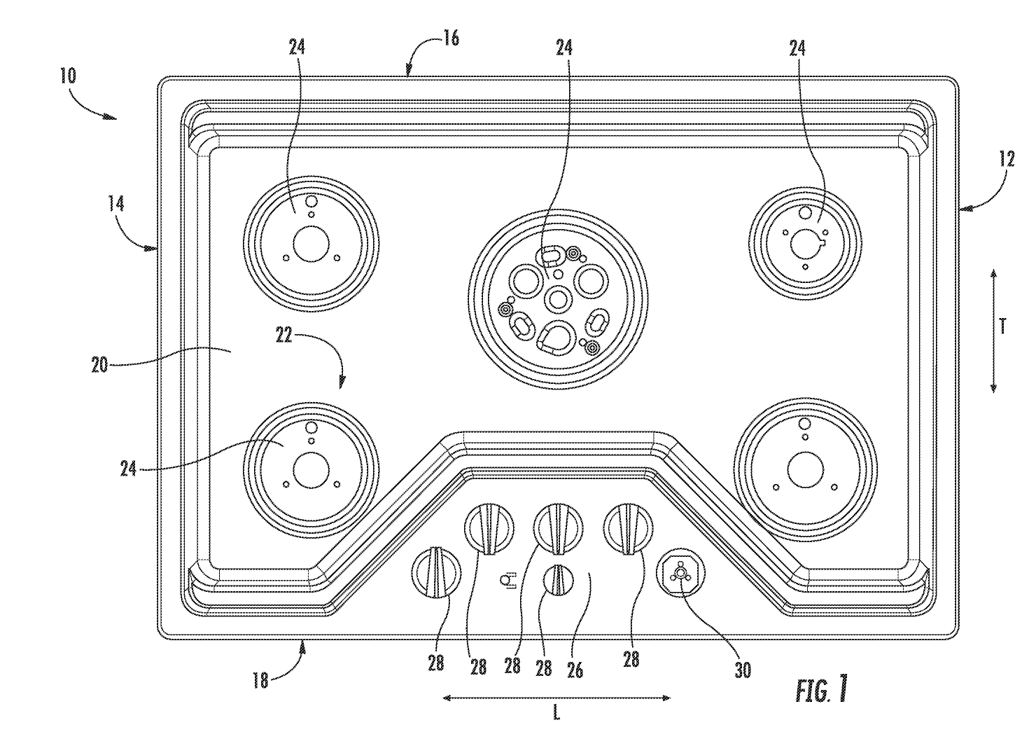

FIG. 1 is a top view of a cooktop appliance 10 in accordance with the embodiments disclosed herein. The cooktop appliance 10 includes a cooktop 20 extending between a left end 12 and a right end 14 along a lateral direction L and between a rear end 16 and a front end 18 along a transverse direction T. The cooktop 20 includes a top surface 22 and one or more gas burners 24 for heating pots, pans, or other cooking vessels (not shown). The embodiment illustrated in FIG. 1 includes five gas burners 24, but cooktop appliance 10 may have more or less gas burners 24 as is necessary or desired.

The cooktop appliance 10 includes a control panel 26 having controls, such as one or more knobs 28, for controlling the one or more gas burners 24. The one or more knobs 28 may turn the one or more gas burners 28 on and off and/or control the flow rate of gas to the one or more gas burners 28, which, in turn, controls the temperature thereof. Each of the one or more knobs 28 may control one of the one or more gas burners 28. Alternately, each of the knobs 28 may control more than one of the gas burners 28. The cooktop 20 may include graphics and/or other insignia (not shown) indicating how the various positions of the knobs 28 correspond to burner activation (e.g., on or off) and/or burner temperature (e.g., high heat, medium heat, or low heat). In the embodiment illustrated in FIG. 1, the control panel 26 includes six knobs 28 (one knob is removed for purposes of illustration), but the control panel 26 may include more or less knobs 28 as is needed or desired. The control panel 26 may include controls (e.g., knobs, switches, button, etc.) for other features, such as an oven (not shown), a fan/vent (not shown), or lights (not shown). The control panel 26 may be horizontal as illustrated in FIG. 1, vertical, or angled.

As mentioned above, one of knobs 28 is removed for purposes of illustration. In this respect, FIG. 1 illustrates a cooktop aperture 30 defined by the control panel 26 portion of the cooktop 20 below where the missing knob would be positioned. A similar cooktop aperture is defined by the cooktop 20 below each of knobs 28.

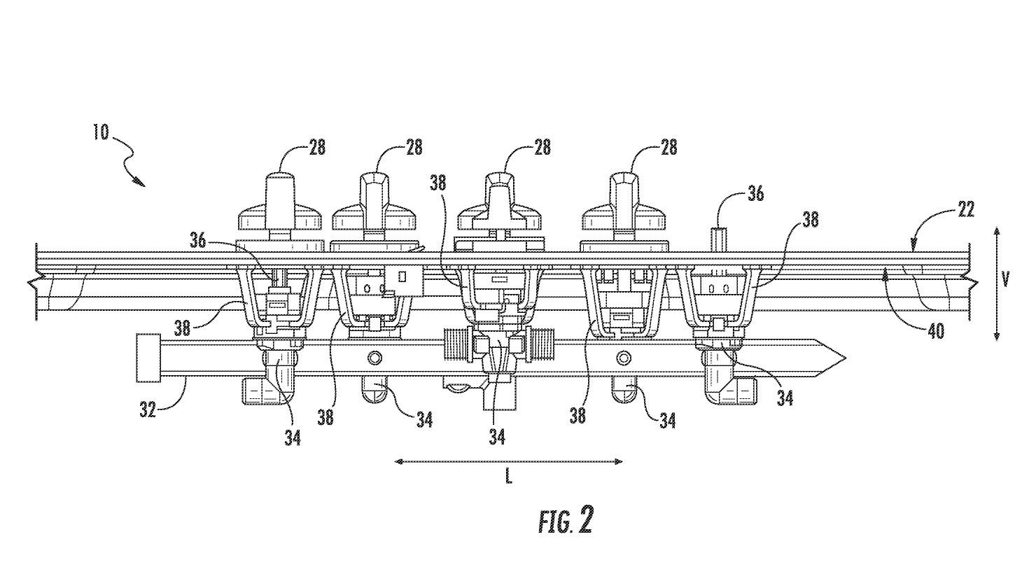

FIG. 2 is a side view of the cooktop appliance 10. The cooktop 20 extends between the top surface 22 and a bottom surface 40 along a vertical direction V. As such, the knobs 28 are positioned vertically above the top surface 22 of the cooktop 20. One or more gas valves 34 are positioned vertically below the bottom surface 40 of the cooktop 20. Each of gas valves 34 may correspond to one or more of the knobs 28. In this respect, the gas valves 34 each include a valve stems 36 extending upwardly in the vertical direction through the cooktop apertures 30. One of the knobs 28 is removed in FIG. 2 for purposes of illustration. The knobs 28 attach to the valve stems 36, thereby permitting each of the knobs 28 to control the gas valve 28. That is, the valve stems 36 transmit the rotation of the knobs 28 through the cooktop 20 to the gas valves 34. One or more brackets 38, which will be discussed in greater detail below, directly mount the gas valves 34 to the bottom surface 40 of the cooktop 20.

The cooktop appliance 10 also includes a manifold 32 positioned vertically below the bottom surface 40 of the cooktop 20. The manifold 32 receives a gas (e.g., natural gas) from a gas source (not shown). Each of the gas valves 34 connects to and is in fluid communication with the manifold 32. In this respect, each of the gas valves 34 controls the flow of the gas from the manifold 32 to the respective gas burner(s) 24. The manifold 32 may have any suitable cross-sectional shape (e.g., rectangular, square, circular, etc.).

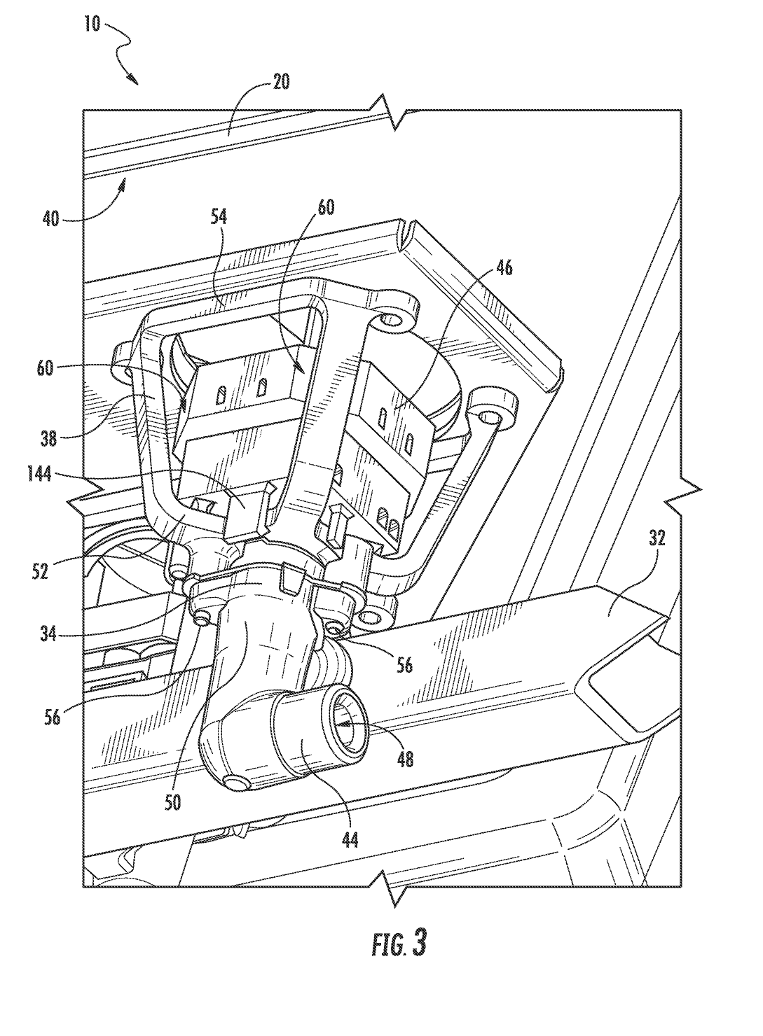

FIG. 3 is a perspective view of one of the gas valves 34 mounted to the bottom surface 40 of the cooktop 20. The gas valve 34 includes a valve body 50 housing a valve mechanism (not shown), which controls the flow of the gas through the gas valve 34. The valve stem 36 actuates the valve mechanism. An inlet pipe 42 and an outlet pipe 44, which defines an outlet port 48, extend outwardly from the valve body 50. In this respect, the gas flows from the manifold 32 into the gas valve 34 via the inlet pipe 42 and exits the gas valve 34 via the outlet pipe 44 en route to one or more of the gas burners 24.

The bracket 38 includes a first flange 52 and a second flange 54. The first flange 52 couples to the valve body 50 via one or more fasteners 56. The second flange 54 couples to the bottom surface 40 of the cooktop 20 via one or more fasteners (not shown). Although, the first flange 52 and the second flange 54 may respectively attach to the valve body 50 and the bottom surface 40 via any suitable method (e.g., welding, brazing, adhesive, etc.). The first flange 52 and the second flange 54 are vertically spaced apart, which may provide clearance for an electronics enclosure 46.

FIG. 4 is a perspective view of the control panel 26 with the cooktop 20 removed. The right, front knob has been removed to better illustrate the electronics enclosure 46, which may house various sensors (not shown) and/or circuitry (not shown) associated with the respective gas valve 34 or the gas burner 24. The electronics enclosure 46 may be positioned between the first flange 52 and the second flange 54 of the bracket 38. The electronics enclosure 46 includes a central passage 58 that provides clearance for the valve stem 36. That is, the electronics enclosure 46 extends circumferentially around the valve stem 36. One or more hooks 144 may couple the electronics enclosure 46 to the bracket 38. In the embodiment illustrated in FIG. 4, the electronics enclosure 46 has a generally cuboid shape with one or more chamfered edges 60. Although, the electronics enclosure 46 may have any suitable shape.

As illustrated in FIG. 4, the gas valves 34 may have one outlet pipe 44 (the front, right gas valve 34) or two outlet pipes 44 (front, left gas valve 34). In this respect, the gas valve 34 may control one gas burner 34 if the gas valve 34 has one outlet pipe 44. Analogously, the gas valve 34 may control two gas burners 34 if the gas valve 34 has two outlet pipes 44. Furthermore, the outlet pipes 44 may have a smooth outer surface (the front, right outlet pipe 44) or a threaded outer surface (the front, left outlet pipe 44).

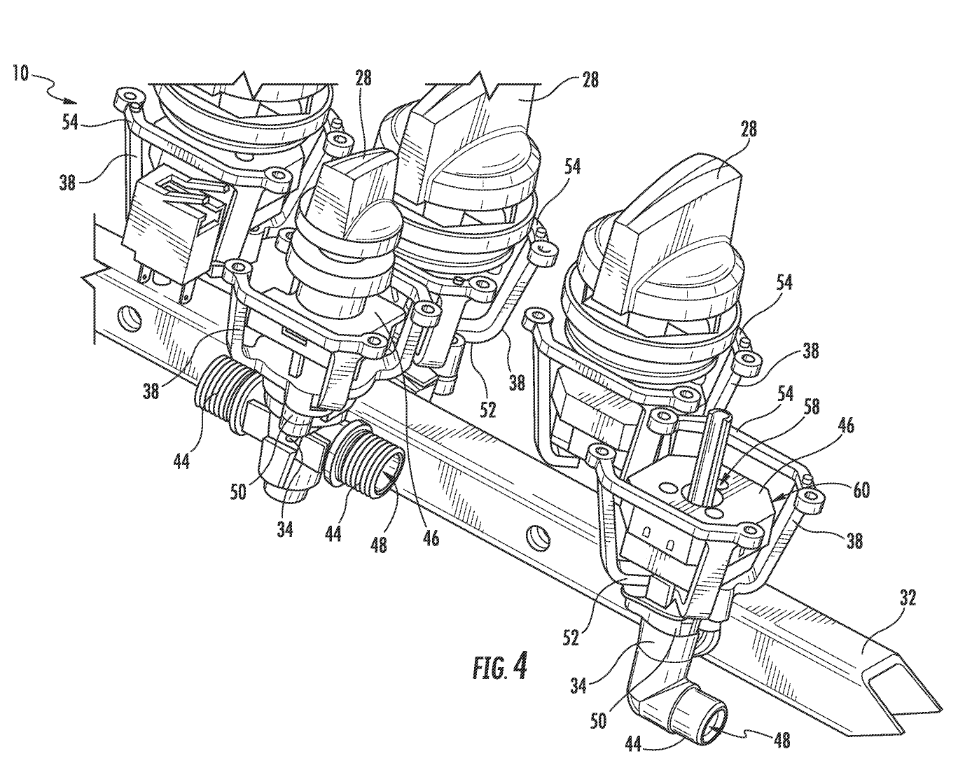

FIGS. 5-7 are enlarged perspective views of the gas valve 34 and the bracket 38. In this respect, the valve stem 36 of the valve defines a valve stem axis A. A radial direction R is defined as extending orthogonally outward from the valve stem axis A. A circumferential direction C is defined as extending concentrically around the valve stem axis A.

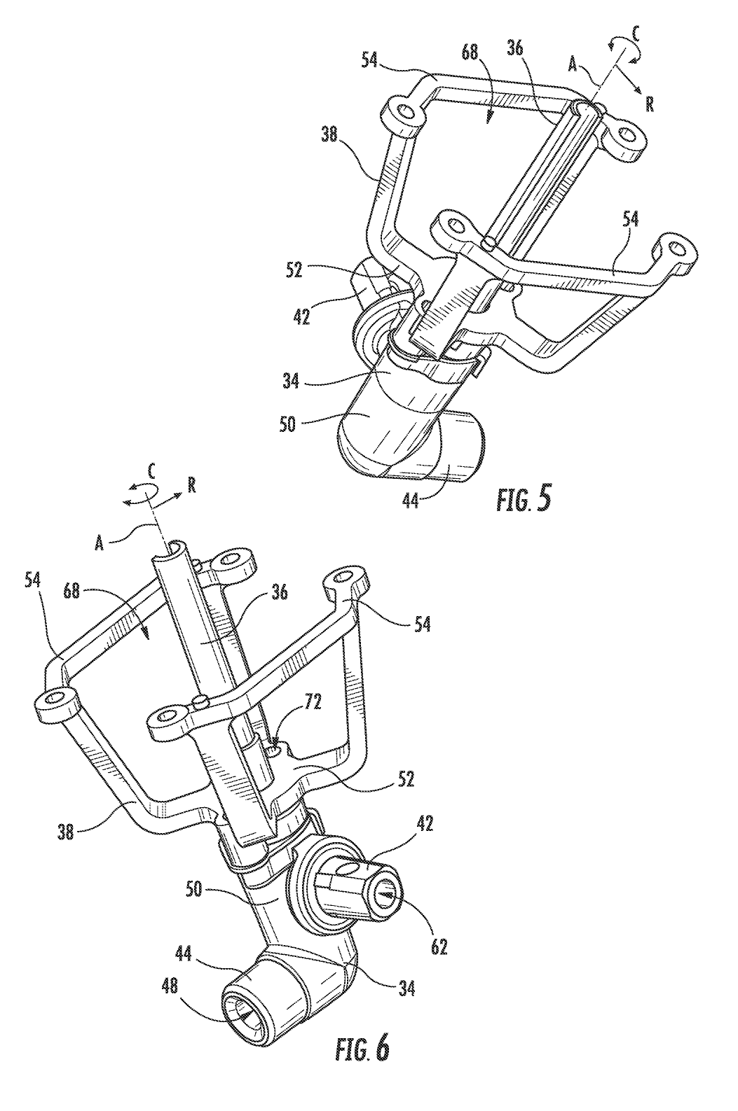

As mentioned above, the gas valve 34 includes the valve body 50, the inlet pipe 42, and the outlet pipe 44. FIG. 6 further illustrates that the inlet pipe 42 defines an inlet port 62. The inlet pipe 42 and the outlet pipe 44 may be vertically spaced apart along the valve stem axis A and/or circumferentially spaced apart. In the embodiment illustrated in FIGS. 5 and 6, for example, the inlet pipe 42 is positioned above the outlet pipe 44 along the valve stem axis A. Furthermore, the inlet pipe 42 and the outlet pipe 44 are circumferentially spaced apart by ninety degrees. Nevertheless, the inlet pipe 42 and the outlet pipe 44 may be aligned along the valve stem axis A and/or in the circumferential direction.

As mentioned above, the bracket 38 attaches the gas valve 34 to the cooktop 20 and includes the first flange 52 and the second flange 54, which are vertically spaced apart along the valve stem axis A. The first flange 52 defines a first flange aperture 66, and the second flange 54 defines a second flange aperture 68. When the gas valve 34 and the bracket 38 are mated, a top surface 70 of the valve body 50 contacts the first flange 53. In this respect, the valve body 50 may include one or more mounting apertures 74, and the bracket 38 may include one or more mounting apertures 72. The mounting apertures 74 and the mounting apertures 72 align to receive the fasteners 56, thereby coupling the bracket 38 to the gas valve 34. The valve stem 36 extends upwardly along the valve stem axis A through the first flange aperture 66 and preferably through the second flange aperture 68 for attachment to one of the knobs 28.

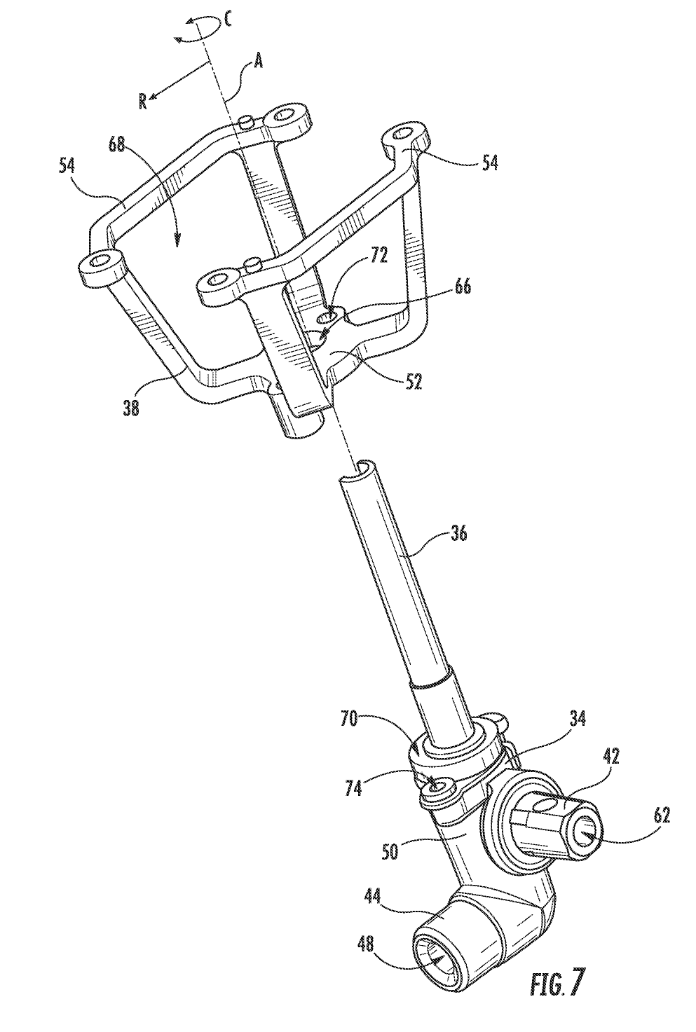

FIGS. 8-11 are perspective, top, front, and side views of the bracket 38, illustrating the various features thereof. As mentioned above, the bracket 38 includes a first flange 52 vertically spaced apart from a second flange 54 along the valve stem axis A. In this respect, the first flange 52 defines a first flange plane FFP, and the second flange defines a second flange plane SFP vertically spaced apart from the first flange plane FFP along the valve stem axis A.

The bracket 38 includes one or more legs 64 extending between and integrally connecting the first flange 52 and the second flange 54. In one embodiment, each of the legs 64 may extend radially outwardly as the legs 64 extend vertically between the first flange 52 and the second flange 54. In this respect, the legs 64 may extend linearly or arcuately from the first flange 52 to the second flange 54. In the embodiment illustrated in FIGS. 8-11, the bracket 38 includes four legs 64. Although, the bracket 38 may include more or less legs 64 as is necessary or desired. The legs 64 may have any suitable cross-sectional shape (e.g., rectangular, square, circular, etc.).

Each of the legs 64 are, for this exemplary embodiment, slender shaft-like or rod-like members. That is, the length of each of the legs 64 is substantially longer (e.g., five time longer, ten times longer, etc.) than the cross-section dimensions (e.g., width, thickness, diameter, etc.) thereof. In this respect, the legs 64 define a one or more passageways 84, 86, 88, 90 therebetween. The passageways 84, 86, 88, 90 permit air to flow to the gas valve 34 and reduce the amount of material necessary to form the bracket 38. Preferably, the legs 64 define an equal number of passageways 84, 86, 88, 90. In the embodiment shown in FIGS. 8-11, for example, the four legs 64 define a front passageway 84, a rear passageway 86, a right side passageway 88, and a left side passageway 90. Nevertheless, the legs 64 may define more or less passageways as is necessary or desired. Depending on the circumferential arrangement of the legs 64 around the valve stem axis A, the passageways 84, 86, 88, 90 may be the same size or different sizes. That is, the passageways 84, 86, 88, 90 may be the same size if the legs 64 are evenly spaced apart in the circumferential direction (e.g., every ninety degrees as in FIGS. 8-11), and the passageways 84, 86, 88, 90 may be different sizes if the legs 64 are unevenly circumferentially spaced apart.

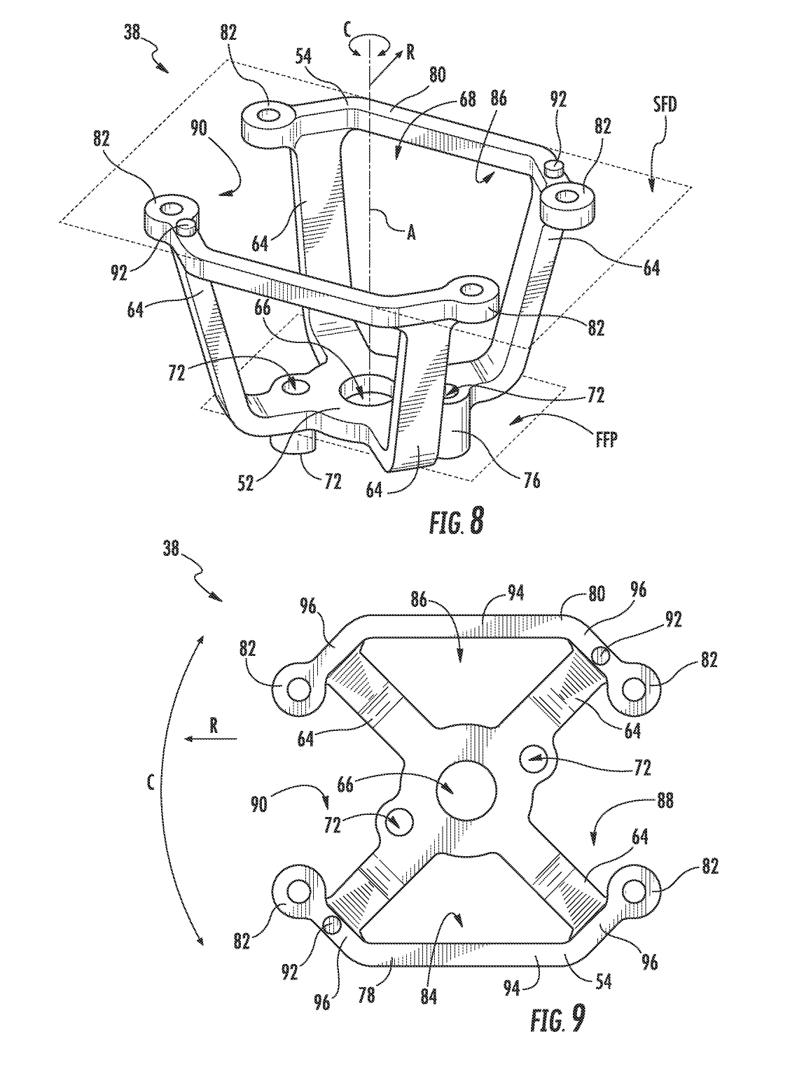

The second flange 54 may include a first bridge 78 and a second bridge 80, both of which lie in the second flange plane SFP. The first bridge 78 extends circumferentially between the front legs 64, and the second bridge extends circumferentially between the rear legs 64. The first bridge 78 and the second bridge 80 are positioned radially outward from the valve stem axis A. As best illustrated in FIG. 9, the first bridge 78 and the second bridge 80 are circumferentially spaced apart. In this respect, the front passageway 84 is enclosed by the first flange 52, the front legs 64, and the first bridge 78. Similarly, the rear passageway 86 is enclosed by the first flange 52, the rear legs 64, and the second bridge 80. The right side passageway 88 and the left side passageway 90 are only enclosed by the legs 64 and the first flange 52. That is, the right side passageway 88 and the left side passageway 90 are only enclosed on three sides and, thus, extend upwardly along the valve stem axis through the second flange 54. In alternate embodiments, however, the second flange 54 may be a single member positioned radially outward from the valve stem axis A that extends around the entire circumference thereof.

The front bridge 78 and the rear bridge 80 may form any suitable shape. In the embodiment shown in FIGS. 8-11, for example, the front bridge 78 and the rear bridge 80 may form an arcuate shape. In this respect, the front bridge 78 and the rear bridge 80 may each include a central bridge portion 94 and two outer bridge portions 96, each extending circumferentially outward from and radially inward from one end of the central bridge portion 94. Although, the front bridge 78 and the rear bridge 80 may form a semicircle, triangle, line, curve, etc. The front bridge 78 and the rear bridge 80 may have any suitable cross-sectional shape (e.g., rectangular, square, circular, etc.). Like the legs 64, the front bridge 78 and the rear bridge 80 are preferably slender. That is, the length of each of the front bridge 78 and the rear bridge 80 is substantially longer (e.g., five time longer, ten times longer, etc.) than the cross-section dimensions (e.g., width, thickness, diameter, etc.) thereof.

The second flange 54 further includes a plurality of connectors such as a plurality of collars 82 for attaching the bracket 38 to the bottom surface 40 of the cooktop 20. The collars 82 may receive fasteners, such as screws, bolts, rivets, etc. (not shown), which couple the bracket 38 to the cooktop 20. In the embodiment illustrated in FIGS. 8-11, the collars 82 are integrally attached to each end of the front bridge 78 and the rear bridge 80. As such, second flange 54 may include four collars 82. Although, the second flange 54 may include more or less collars 82 as is necessary or desired. Moreover, the collars 82 may be positioned anywhere on the second flange 54. The collars 82 may be evenly space apart in the circumferential direction C (e.g., every ninety degrees) or unevenly spaced apart as shown in FIG. 9. Alternately, the plurality of connectors may a plurality of tabs (not shown) having through holes punched or drilled therein. The plurality of tabs may be configured for attachment to the cooktop 20 via welding or brazing.

The second flanges may include one or more bosses 92 extending vertically upward therefrom. The bosses 92 may be for vertically spacing the bracket 38 apart from the bottom surface 40 of the cooktop 20 or may simply be a remnant of the manufacturing process (e.g., a sprue). The embodiment illustrated in FIGS. 8-9 includes two bosses 92. Specifically, one of the two bosses 92 is positioned on the left side of the first bridge 78, and the other of the two bosses 92 is positioned on the right side of the second bridge 80. Nevertheless, the second flange 54 may include more or less bosses 92, and the bosses 92 may be positioned anywhere on the second flange 54. As illustrated in FIGS. 9-11, the bosses 92 have a circular cross-section; although, the bosses 92 may have any suitable cross-section (e.g., rectangular, square, etc.).

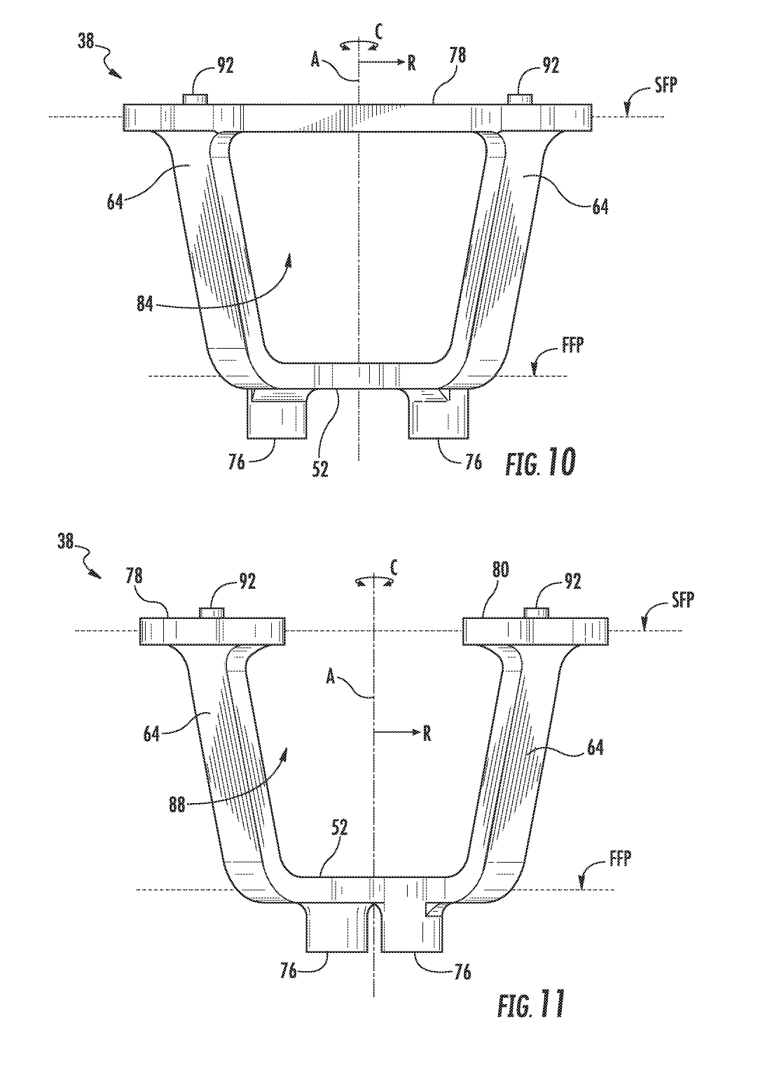

The first flange 52 includes a top surface 98 and a bottom surface 100 vertically spaced part from the top surface 98. A plurality of mounting bosses 76 extend downwardly from the bottom surface 100 of the first flange 52. The mounting apertures 72 extend from the top surface 98 of the first flange 52 through the mounting bosses 76. In this respect, the mounting bosses 76 provide additional clearance for the fasteners 56. The first flange 52 may include two mounting bosses 76 as illustrated in FIGS. 10 and 11, but may include more or less mounting bosses 76 as is needed or desired.

As illustrated in FIG. 8, the second flange aperture 68 may be relatively larger than the first flange aperture 66. More specifically, the first flange aperture 52 may be sized and shaped to prevent radial movement of the gas valve 34 or the valve stem 36. The second flange aperture 68 may be sized and shaped to for attachment to the bottom surface 40 of the cooktop 20 radially outward from the cooktop aperture 30. In this respect, the second flange aperture is larger than the cooktop aperture 30, which is larger than the valve stem 36.

As briefly discussed above and best illustrated in FIGS. 5-7, the bracket 38 couples the gas valve 34 to the bottom surface 40 of the cooktop 20. More specifically, the valve stem 36 slides through the first flange aperture 66 until the bottom surface 100 of the first flange 52 contacts the top surface 70 of the valve body 50. The fasteners 56 couple the gas valve 34 to the bracket 38. The electronics enclosure 46 may be coupled to the bracket 38 via the hooks 144. The second flange 54 is placed against the bottom surface 40 of the cooktop 20. In this respect, the valve stem 36 extends through the cooktop aperture 30 for placement of a knob 28 thereon. The collars 82, which receive fasteners (not shown), couple the bracket 38 to the bottom surface 40 of the cooktop 20. As such, the bracket 38 directly connects the gas valve 34 to the cooktop 20, thereby improving the positioning of the valve stem in the cooktop aperture 30 and the alignment of the knob 28 with any graphics or insignia.

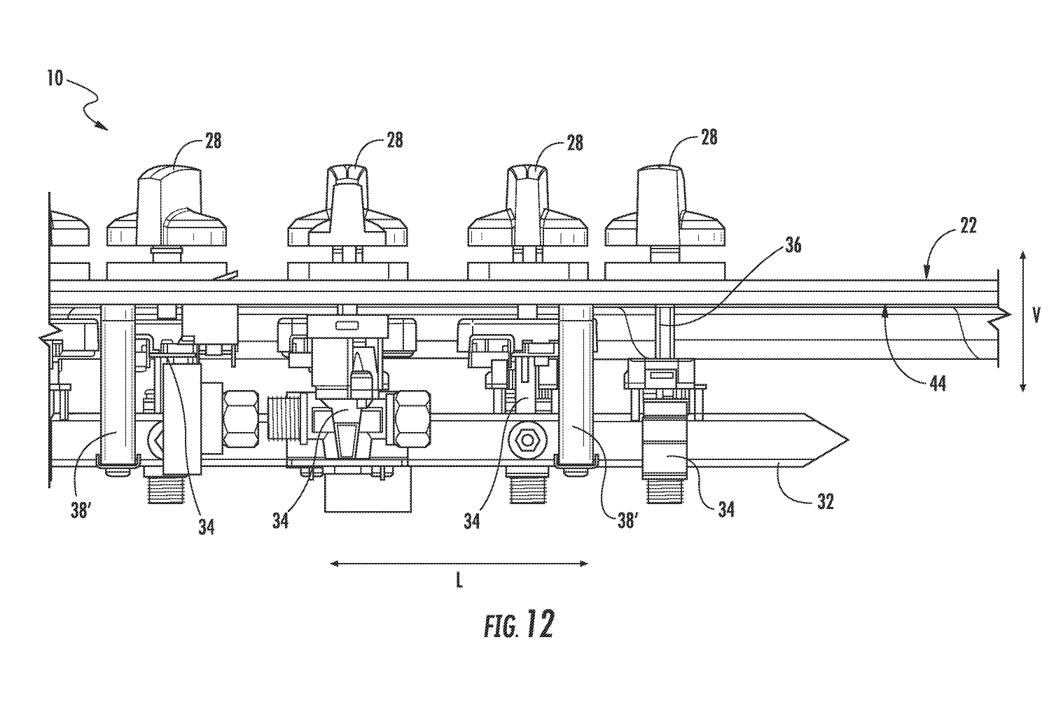

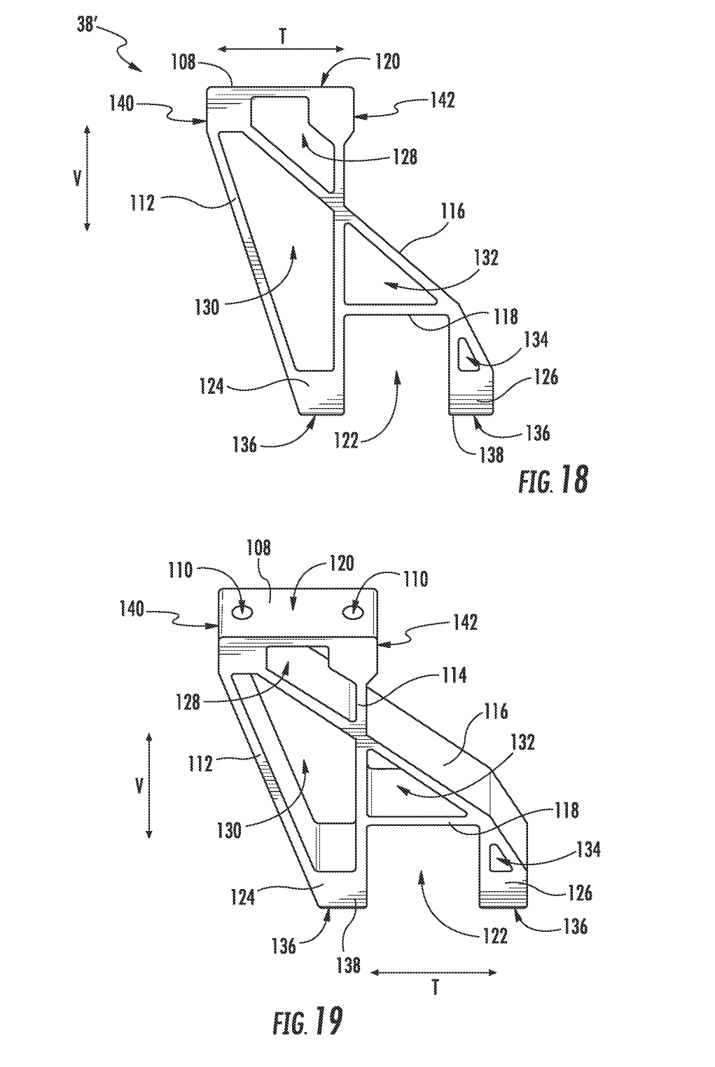

FIGS. 12-19 illustrate an alternate embodiment of the bracket 38′ for use in positioning the knobs 28 relative to the cooktop aperture 30 and/or graphics/insignia on the cooktop 30. In particular, the FIG. 12 is a side view of the cooktop appliance 10 similar to FIG. 2. Unlike the bracket 38 illustrated in FIGS. 2-11, the bracket 38′ indirectly couples the gas valve 34 to the bottom surface 40 of the cooktop 20. More specifically, the bracket 38′ couples the manifold 32 to the bottom surface 40 of the cooktop 20. The plurality of valves 34 is, in turn, coupled to the manifold 32. The plurality of valve stems 36 extend vertically upward from the plurality of valves 34 through the plurality of cooktop apertures 30. The plurality of knobs 28 attach to the plurality of valve stems 36.

FIG. 13 is a perspective view of the manifold 32 mounted to the cooktop 20 with the bracket 38′. The gas valve 34 has been removed for clarity. The bracket 38′ includes first flange 108 that mates with the bottom surface 40 of the cooktop 20 and a second flange 138 that defines a notch 122 (FIGS. 17-19) for reception of the manifold 32. The manifold 32 may fit entirely with the notch 122 as illustrated in FIG. 13 or may only fit partially in the notch 122. A cap 102 secured to the second flange 138 via, e.g., one or more fasteners 104, spans the notch 122 to retain the manifold 32 therein.

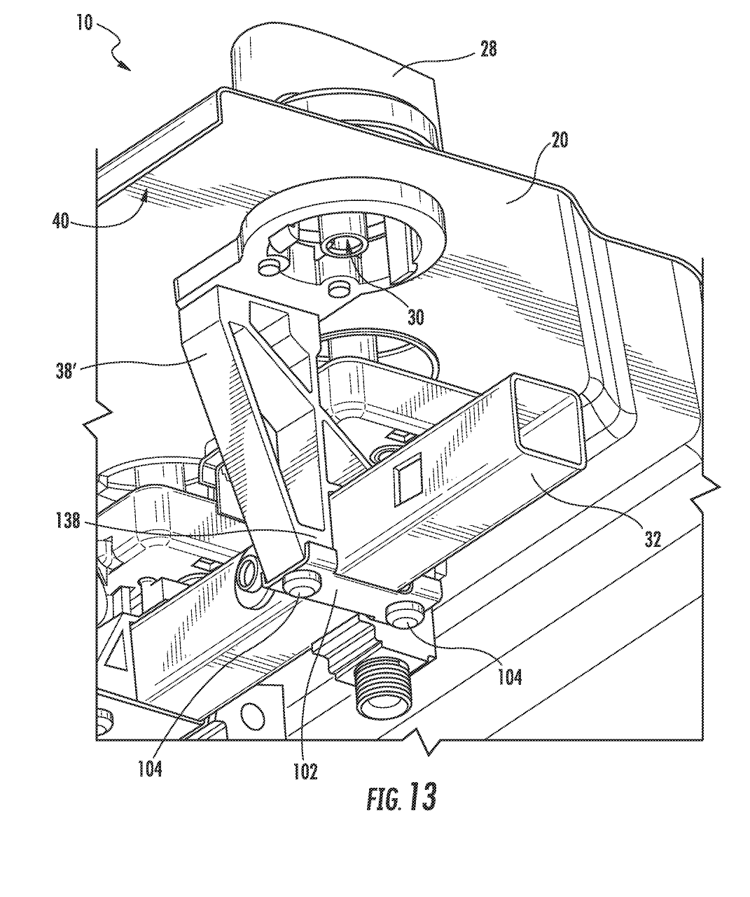

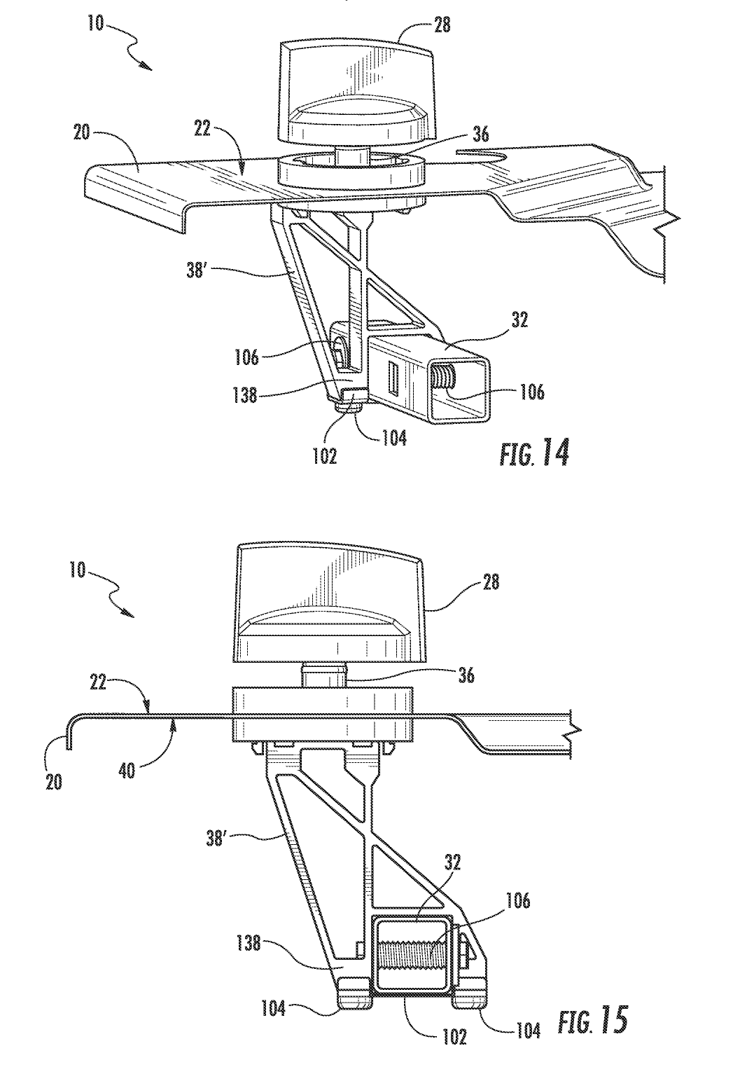

FIGS. 14-15 illustrate a fastener 106 that may attach the gas valve 34 (not shown in FIGS. 14-15) to the manifold 32. Preferably, one fastener 106 attaches each gas valve 34 to the manifold 32; although, more fasteners 106 may be used as is needed or desired. The fastener 106 may be a bolt, screw, rivet, etc.

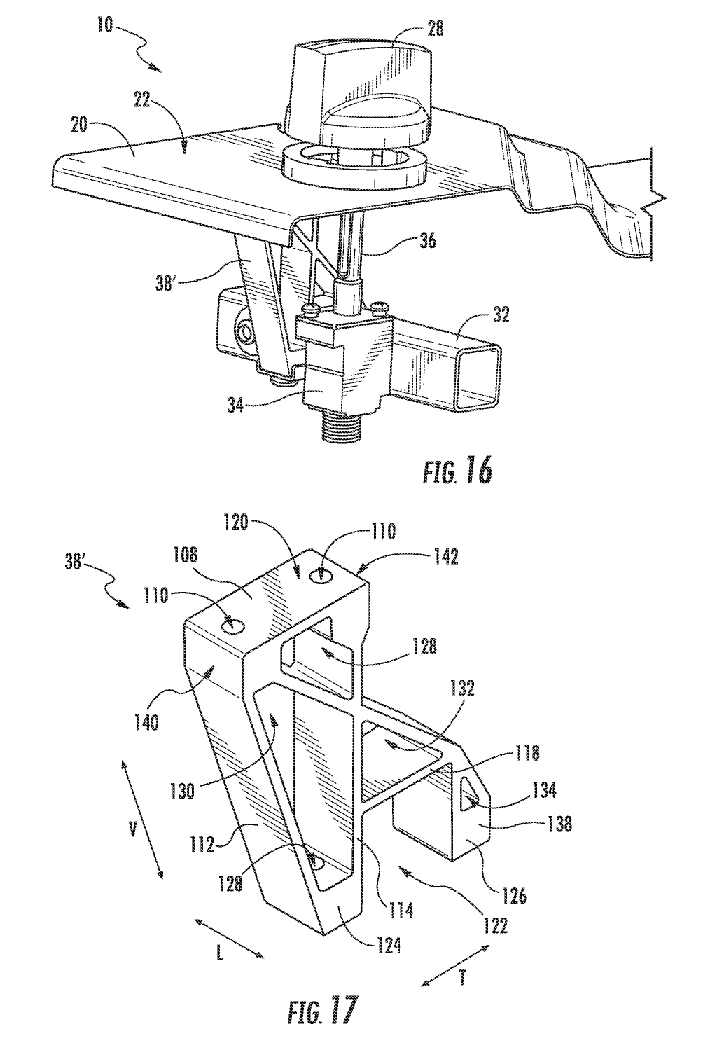

FIG. 16 is a perspective view of the gas valve 34 and the bracket 38′ mounted to the cooktop 30. As illustrated, the gas valve 34 and the bracket 38 are spaced apart along the manifold 32. In this respect, the gas valve 34 and the bracket 38′ do not mate.

FIGS. 17-19 are perspective, side, and top-side views of the bracket 38′, illustrating the various features thereof. As illustrated in FIGS. 17-19, the bracket 38′ defines the vertical direction V, the lateral direction L, and the transverse direction T.

As mentioned above, the bracket 38′ includes the first flange 108. More specifically, the first flange 108 includes a first end 140, a second end 142 transversely spaced apart from the first end 140, and a flat top surface 120 for mating with the bottom surface 40 of the cooktop 20. The first flange 108 further includes one or more mounting apertures 110, which receive one or more fasteners (not shown) for securing the bracket 38′ to the cooktop 30. The embodiment illustrated in FIGS. 17 and 19 includes two mounting apertures 110. Although, the first flange 108 may include more or less mounting apertures 110 as is necessary or desired. The first flange 108 may include thicker portions where the mounting apertures 110 are positioned to provide clearance therefor as illustrated in FIGS. 17 and 19. Alternately, the entirety of the first flange 108 may have the same thickness.

The bracket 38′ also includes the second flange 138, which has a first side portion 124 transversely spaced apart from a second side portion 126. The first side portion 124 and the second side portion 126 at least partially define the transverse sides of the notch 122 as will be discussed in greater detail below. The second flange 138 further includes a flat bottom surface 136 for mating with the manifold 32. The second flange 138 includes one or more mounting apertures (not shown), which receive the fasteners 104 for securing the cap 102 to the bracket 38′.

A plurality of walls may extend between the first flange 108 and the second flange 138. One embodiment of the plurality of walls, for example, is illustrated in FIGS. 17-19. More specifically, a first wall 112 extends angularly between the first end 140 of the first flange 108 and the first side portion 124 of the second flange 138. That is, the first wall 112 extends vertically and transversely between the first flange 108 and the second flange 138. A second wall 114 extends vertically between the second end 142 of the first flange 108 and the first side portion 124 of the second flange 138. In this respect, the second wall 114 is disposed at an angle relative to the first wall 112. A third wall 116 extends angularly between the first end 140 of the first flange 108 and the second side portion 126 of the second flange 138. That is, the third wall 116 extends vertically and transversely between the first flange 108 and the second flange 138. In this respect, the third wall 116 intersects the second wall 114 and is disposed at an angle relative to the first wall 112 and the second wall 114. A fourth wall 118 extends horizontally between the second wall 114 and the third wall 116, thereby forming the vertical boundary of the notch 122. Other embodiments of the bracket 38′ may have more or less walls and the walls may be arranged differently.

The bracket 38′ may include a plurality of passageways extending through the bracket 38′ in the lateral direction L. For example, the first flange 108, the second flange 138, and the walls 112, 114, 116, 118 may define a first passageway 128, a second passageway 130, a third passageway 132, and a fourth passageway 134 as illustrated in FIGS. 17-19. The plurality of passageways reduces the amount of material necessary to form the bracket 38′, thereby reducing manufacturing cost.

The first passageway 128 is defined by the first flange 108, a portion of the second wall 114, and a portion of the third wall 116. If the first flange 108 is has a uniform thickness, the first passageway 128 may be triangular. Alternately, the first passageway 128 may also be six-sided as in FIGS. 17-19 if the first flange 108 has thicker regions proximate to the mounting apertures 110. Although, the first passageway 128 may have any suitable shape (e.g., quadrilateral, etc.).

The second passageway 130 may have a generally pentagonal shape. In this respect, the second passageway 130 is defined vertically between the first end 140 of the first flange 108 and the first side portion 124 of the second flange 138. The second passageway 130 is also defined laterally between the first wall 112 and portions of the second wall 114 and the third wall 116. Although, the second passageway 130 may have any suitable shape (e.g., quadrilateral, etc.).

The third passageway 132 is defined by portion of the second wall 114 and the third wall 116 as well as the fourth wall 118. In this respect, the third passageway 126 may be triangular. Although, the third passageway 128 may have any suitable shape (e.g., quadrilateral, etc.).

A fourth passageway 134 may be defined by the second side portion 126 of the second flange 138. The fourth passageway 134 may be triangular as illustrated in FIGS. 17-19. Although, the fourth passageway 128 may have any suitable shape (e.g., quadrilateral, etc.).

Other embodiments of the bracket 38′ may have more or less passageways defined therein and the passageways may be arranged differently and/or have different shapes.

As mentioned above, the bracket 38′ also includes the notch 122 for receiving the manifold 32. As illustrated in FIGS. 17-19, the notch 122 is defined by the first side portion 124 of the second flange 138, the second wall 114, the fourth wall 118, and the second side portion 126 of the second flange 138. In particular, the first side portion 124 of the second flange 138, the second wall 114, and the second side portion 126 of the second flange 138 define the boundaries of the notch 122 in the transverse direction T and the fourth wall 118 defines the upper boundary of the notch 122 in the vertical direction V. Although, the second wall 114 may not define a portion of the notch 122 if the fourth wall 118 is positioned vertically lower. The notch 122 extends through the bracket 38′ in the lateral direction L. In one embodiment, the notch 122 has a rectangular or square cross-section. Although, the notch 122 may have any suitable cross-sectional shape (e.g., semicircular, triangular, etc.). Nevertheless, the cross-sectional shape of the notch 122 preferably is the same as the cross-sectional shape of the manifold 32.

As briefly discussed above and best illustrated in FIGS. 15-16, the bracket 38′ couples the manifold 32 to the bottom surface 40 of the cooktop 20. More specifically, the top surface 120 of the first flange 108 contacts the bottom surface 40 of the cooktop 20. Fasteners (not shown) engage the mounting apertures 110 to couple the bracket 38′ to the cooktop 20. The gas valve 34 fluid connects to the manifold 32. The valve stem 36 of the gas valve 34 slides through the cooktop aperture 30, and the notch 122 receives the manifold 32. The fasteners 104 connect the cap 102 to the bottom surface 136 of the second flange 138, thereby securing the manifold 32 to the bracket 38′.

The brackets 38, 38′ are preferably manufactured via die casting or injection molding. In this respect, the brackets 38, 38′ may have tighter tolerances and greater repeatability than conventional sheet metal brackets constructed via stamping and/or bending operations.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A gas valve mounting assembly, comprising:
a gas valve comprising:
a valve body; and
a valve stem extending outwardly from the valve body and defining a valve stem axis, wherein a radial direction is defined as orthogonal to the valve stem axis and a circumferential directional is defined as concentric to the valve stem axis; and
a bracket comprising:
a first flange;
a first flange aperture defined by the first flange and aligned with the valve stem axis, wherein the valve stem is received at least partially within the first flange aperture;
a second flange for attachment to a cooktop, the second flange spaced apart from the first flange along the valve stem axis;
a second flange aperture defined by the second flange and through which the valve stem extends from the valve body; and
a plurality of connectors disposed on the second flange for attaching the bracket to the cooktop.

2. The gas valve mounting assembly of claim 1, further comprising a plurality of legs extending between the first flange and the second flange.

3. The gas valve mounting assembly of claim 2, wherein of the plurality of legs are spaced apart from each other along the circumferential direction.

4. The gas valve mounting assembly of claim 2, wherein the first flange defines a first flange plane and the second flange defines a second flange plane spaced apart from the first flange plane along the valve stem axis, and wherein the second flange comprises a pair of bridges lying in the second flange plane and connecting adjacent pairs of the plurality of legs.

5. The gas valve mounting assembly of claim 2, further comprising at least one passageway extending between each adjacent pair of the plurality of legs, the passageways permitting air flow therethrough from an aperture in the cooktop to a burner.

6. The gas valve mounting assembly of claim 1, wherein the plurality of connectors comprises a plurality of collars for receiving fasteners.

7. The gas valve mounting assembly of claim 1, wherein the first flange comprises a plurality of mounting bosses for receiving fasteners for securing the valve body to the bracket.

8. The gas valve mounting assembly of claim 1, wherein the pair of bridges are generally arcuate-shaped.

9. The gas valve mounting assembly of claim 1, wherein the bracket is die-cast or injection molded.

10. The gas valve mounting assembly of claim 4, wherein the first flange defines one or more mounting apertures for the valve body.

11. A cooking appliance, comprising:
a manifold for supplying gas to one or more burners;
a gas valve for controlling the flow of gas out of the manifold, the gas valve comprising:
a valve body; and
a valve stem extending outwardly from the valve body and defining a valve stem axis, wherein a radial direction is defined as orthogonal to the valve stem axis and a circumferential directional is defined as concentric to the valve stem axis; and
a bracket for mounting the gas valve to a cooktop, the bracket comprising:
a first flange;
a first flange aperture defined by the first flange and aligned with the valve stem axis, wherein the valve body is received at least partially within the first flange aperture;
a second flange for attachment to a cooktop, the second flange spaced apart from the first flange along the valve stem axis;
a second flange aperture defined by the second flange and through which the valve stem extends from the valve body;
a plurality of legs extending between the first flange and the second flange;
at least one passageway between each adjacent pair of the plurality of legs, wherein the passageways permit air flow therethrough from an aperture in the cooktop to a burner; and
a plurality of connectors disposed on the second flange for attaching the bracket to the cooktop.

12. The cooking appliance of claim 11, wherein of the plurality of legs are spaced apart from each other along the circumferential direction.

13. The cooking appliance of claim 11, wherein at least one of the plurality of legs are generally arcuate-shaped.

14. The cooking appliance of claim 11, wherein the plurality of connectors comprises a plurality of collars for receiving fasteners.

15. The cooking appliance of claim 11, wherein the first flange defines a plurality of mounting apertures for receiving fasteners for securing the valve body to the bracket.

16. The cooking appliance of claim 11, wherein the first flange defines a first flange plane and the second flange defines a second flange plane spaced apart from the first flange plane along the valve stem axis, and wherein the second flange comprises a pair of bridges lying in the second flange plane and connecting adjacent pairs of the plurality of legs.

17. The cooking appliance of claim 11, wherein the bracket is die-cast or injection molded.

18. A gas valve mounting assembly, comprising:
a gas valve; and
a bracket comprising:
a first flange for attachment to a cooktop;
a second flange;
a notch defined by the first flange for receiving a manifold;
a first wall extending between the first flange and the second flange;
a second wall extending between the first flange and the second flange, the second wall disposed at an angle relative to the first wall;
a third wall extending between the first flange and the second flange, the third wall intersecting the second wall and disposed at an angle relative to the first wall and the second wall; and
a plurality of connectors disposed on the second flange for attaching the bracket to the cooktop.

19. The gas valve mounting assembly of claim 18, wherein the first wall and the second wall connect to the first flange on a first side of the notch and the third wall connects to the first flange on a second side of the notch.

20. The gas valve mounting assembly of claim 18, wherein the bracket is die-cast or injection molded.
